(19) United States
(12) Patent Application Publication
(10) Pub. No.: US 2009/0196526 A1
(43) Pub. Date: Aug. 6, 2009

(54) MICROSCOPY SYSTEM HAVING AUTOMATIC AND INTERACTIVE MODES FOR FORMING A MAGNIFIED MOSAIC IMAGE AND ASSOCIATED METHOD

(75) Inventors: Joachim Helmut Schmid, Windsor (CA); Thomas Gahm, Elon, NC (US); Kevin Russell Kooy, Graham, NC (US); Rainer Dorrer, Mullheim-Vogisheim (DE); Bruno Krief, Toulouse (FR); John Royal Cheeseman, Mebane, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: TriPath Imaging, Inc.

(21) Appl. No.: 12/415,015

(22) Filed: Mar. 31, 2009

Related U.S. Application Data
(62) Division of application No. 11/204,954, filed on Aug. 16, 2005.
(60) Provisional application No. 60/602,463, filed on Aug. 18, 2004.

(51) Int. Cl. G06K 9/64; G06K 9/36

(52) U.S. Cl. 382/278; 382/284

(57) ABSTRACT

A scanning device for biological slides is provided, which can be operated in an interactive routine mode as well as in an unsupervised high speed automatic mode. In the first case, typical components, which the pathologist is used to operating manually, such as the microscope, the stage and the focus, and which have to be motorized for the automatic unsupervised system mode, are configured to simulate manual use, operation, and response. A non-interlaced area scan camera supports the interactive selection and acquisition of individual images in the manual mode, as well as the continuous high-speed scan motion for the rare event detection and virtual slide scan applications of the system. Due to the particular requirements to accommodate both operational modes, methods are described for constructing the virtual slide out of image tiles with varying overlap areas in the x- and y-directions.

### CROSS-REFERENCE TO RELATED APPLICATIONS

This application is a divisional application of U.S. application Ser. No. 11/204,954, filed Aug. 16, 2005, which claims the benefit of U.S. Provisional Application No. 60/602,463, filed Aug. 18, 2004, which are incorporated by reference herein in their entirety.

### BACKGROUND OF THE INVENTION

1. Field of the Invention

The present invention relates generally to the acquisition and analysis of digital images of objects and areas of interest located on a microscopic slide, and more particularly, to a microscopy system having automatic and interactive modes, and associated method, for acquiring, storing, displaying and analyzing digital images of areas of interest on a microscopic slide which can be much larger than a field of view (FOV) of the microscope.

2. Description of Related Art

Microscopic analysis is a widely used tool for research and routine evaluations specifically in the field of cellular biology, cytology and pathology. Tissue samples and cell preparations are visually inspected by pathologists under several different conditions and test procedures with use of microscopes. Based on these visual inspections, determinations concerning the tissue or cellular material can be deduced. For example, in the area of cancer detection and research, microscopic analysis aids in the detection and quantification of genetic alterations that appear related to the cause and progression of cancer, such as changes of expression of specific genes in form of DNA or messenger RNA (gene amplification, gene deletion, gene mutation) or the encoded protein expression. These alterations can either be assessed in microscopic slides specifically prepared to present individual cells, as is the standard procedure in cytology, or whole histological sections or Tissue Micro Arrays can be evaluated. Although numerous other laboratory techniques exist, microscopy is routinely used because it is an informative technique, allowing rapid investigations at the cellular and sub-cellular levels, while capable of being expeditiously implemented at a relatively low cost.

Although a desired research and routine tool, conventional microscopic analysis does have some drawbacks. Due to the limited field of view, which is inherent to the microscope in general, microscopic analysis of tissue samples is typically an iterative process. The pathologist or other user usually begins with a low-resolution magnification setting on the microscope, in which they are able to see a larger area of the sample. From this low-resolution view, the user determines areas of the sample that require closer inspection. These areas are then typically further analyzed using higher magnification levels.

Another drawback is the qualitative nature of the inspection. Although the human operator can very effectively interpret cell and tissue structures and patterns, it is quite challenging to assess the protein expressions of specific markers, for example visualized with immunohistochemistry or immunocytochemistry, in a reproducible way.

To overcome these drawbacks, devices were designed where the microscope was combined with automatic image analysis. These devices range from interactive systems over automatic scanning devices to virtual slide scanners.

Interactive systems usually don't change the workflow of the pathologist analyzing and interpreting slides underneath the microscope. All they typically add is the potential to extract additional quantitative information from the slide via image analysis and therefore possibly improve the reproducibility and the interpretation results of the operator. They also provide better tools to report and document analysis results. Designed properly, interactive systems are fast and cost efficient, but their impact on routine workflow is relatively small.

Automatic rare event detection devices are typically set up in a way that the whole analysis of the slides is done by the system in a totally unsupervised way, from the loading of the slides onto the scanning stage to the final reporting of the results. These systems usually scan the slides, automatically identify objects or areas of interest for the analysis, quantitatively assess these targets, and report and document the results. The routine workflow for the pathologist or cytotechnologist, in general, is changed drastically from a labor intensive screening task to the interpretation of analysis results. However, these systems are normally quite expensive, so that it needs a relatively high yearly volume of slides to be processed to cost-justify the acquisition of such a device.

Virtual slide scanning systems have been developed to automatically acquire large overview images of a slide at different optical resolutions. These overview images can be far larger than the individual FOVs as they can be seen in the microscope.

Typically in a virtual slide scanning device, a motorized stage moves the slide underneath a microscope in such a way that the predefined region of interest, which in the extreme case can be the whole slide, gets recorded by a video camera in a sequential fashion. These images are then merged into one seamless virtual slide.

Virtual slide scanners are typically highly automated systems, which can process the slides in an unsupervised fashion. As these systems are supposed to acquire the images of large areas of a slide, or even the whole slide, they have to be designed as high speed systems. Otherwise, a slide scan at, for example, a 20× magnification can easily take hours.

These different requirements between the three types of applications, mentioned above, are the reason why existing prior art systems are only able to handle one or two of these tasks in a satisfactory way, and fail on the third option. As all three workflows have major complementary advantages, it would be ideal to combine them into one system in a cost efficient way as routine platform for medium-sized and small laboratories. This system would be able to offer a fast interactive way of quantitatively assessing immunohistochemistry (IHC) slides, such as for example the breast panel. The same platform could also be used as an automatic rare event detection system, for example, to find specifically immunocytochemistry (ICC) marked cells in a cytology preparation, such as a liquid-based thin layer slide. The same system would also have the speed and capacity to scan complete slides and to create merged high resolution overview images in an acceptable time frame.

Westerkamp et al. describe, in “Non-Distorted Assemblage of the Digital Images of Adjacent Fields in Histological Sections,” a system and method to create virtual slides out of individual image tiles based on the correct alignment and calibration of a high precision scanning stage. In that way, the grabbed image tiles can be abutted precisely and merged to form the virtual slide. Additionally, the described method corrects for image distortions and slight calibration deviations.

A similar method—without the corrections—is used by the BLISS system by Bacus et al. (U.S. Pat. No. 6,101,265; U.S. Pat. No. 6,272,235). Images of large slide areas are created by acquiring image tiles of contiguous FOVs with an automatic scanning microscope device. To be able to assemble the tiles to a large seamless image, Bacus et al. synchronize the movement of the scanning stage of the automatic microscope as precisely as possible with the size of the field of view, as seen by the system camera, so that the grabbed image tiles may be abutted without any substantial overlap (equal or better than 1 pixel), and without the need of performing any image manipulations.

The success of both procedures relies to a large extent on the high precision and robustness of the scanning stage of 0.5 μm step size and is therefore a likely source of image tile misalignment in routine use. Although this may not be a problem for qualitative slide inspection, it can cause severe inaccuracies in quantitative slide evaluation.

The need to move the stage in precise increments requires a stop and go process, where each image tile can only get acquired when the relative motion between stage and camera is minimal. This leads to small image acquisition frame rates of approximately 1 acquired image tile per second, especially if the settling time of the mechanical stage per stop command is taken into account. The advantage of this method, however, is that individual whole image frames can be acquired and processed, which is the basis for the interactive as well as automatic rare event detection modes.

A similar device is described by Ellis et al. (U.S. Pat. No. 6,418,236, U.S. Pat. No. 6,718,053) with stop and go acquisition of individual image frames.

The speed problem is minimized by Wetzel et al. (U.S. Pat. No. 2002/0090127). The system acquires image tiles in a continuous stage motion using high speed strobe illumination to “optically stop” the motion of the stage. To achieve this, Wetzel et al. use special hardware to acquire image tiles which can be assembled to large composite images, without the tiles either overlapping or missing part of the region of interest. For this purpose, the system includes a Ronchi ruler attached to the motorized stage in combination with a light sensor to precisely determine and track the scanning distance and to trigger the image acquisition at the correct time.

Results in this design are strongly dependent on the perfect alignment and calibration of the motorized stage and the camera, as well as on the pulsed light source and the position sensor. This type of alignment is difficult to maintain in a routine environment, such as a routine and/or research laboratory. Furthermore, the use of special hardware and specifically a strobe light source increases the costs of the system significantly, while at the same time renders the microscope useless for manual routine use.

Soenksen (U.S. Pat. No. 6,711,283) uses a line scan method. If a line scan CCD camera is used, the region of interest is recorded in the form of adjacent bands. This is the result of the linear arrangement of CCD elements in the sensor, which allows, in its simplest form, to record only one line of information at a time, as opposed to the recording of whole image frames as discussed above. This line, however, can get recorded and moved to memory very quickly, so that by moving the slide underneath the microscope with constant speed, line after line can be assembled in memory to create a band, the width of which is determined by the dimension of the linear array of CCD elements, whereas the length is only limited by the stage movement and memory considerations. With this technology, the final overall picture of the region of interest has to be assembled out of a small number of bands, as opposed to a large number of image tiles.

Based on line scan technology and custom hardware, the system disclosed by Soenksen is optimized for acquisition speed as a microscope slide scanner. Although line scan technology is a fast way of acquiring image information, it also has some drawbacks: as usually only one line is acquired at a time to form an image, only this information is available for automatic focusing. This may lead to images where individual lines are out of focus and therefore to reduced image quality. Alternatively, a second standard CCD video camera can be used for focusing, which increases cost and complexity of the design. Imperfections in even just one CCD element of the linear array has a strong impact on the overall image quality and will be visible as a line in each band parallel to the direction of the stage movement. The same defect would lead, in an image which was taken by a standard CCD video camera, just to a degraded pixel per image tile and would be barely visible. The use of a line scan camera also makes it virtually impossible to manually select and acquire individual images.

The discussion of the prior art system designs shows clearly that a more suitable device would combine the advantages of acquiring whole images at a time instead of individual lines, with a similar speed and continuous scan motion as achieved in line scanning, without the extra cost and complication of strobe illumination. To make the system also attractive to small laboratories, it would have to be designed in such a way that the platform is flexible enough to support additional future applications, including fluorescence microscopy, that it supports interactive and automatic operation, and that the results can be displayed and interpreted on a local machine, as well as on remote systems via network.

### BRIEF SUMMARY OF THE INVENTION

The above and other needs are met by the present invention which, in one embodiment, describes a microscopy system having automatic and interactive modes, and associated method, for acquiring, storing, and displaying digital images of areas of interest on a microscopic slide which are at least as large as a field of view (FOV) of the microscope.

In view of the deficiencies of the existing image scan devices and methods, the present invention provides a robust, error-tolerant, cost-efficient, high-speed system and method for collecting and assembling contiguous image tiles to form large overview images (virtual slides) of excellent quality with a minimum need for system alignment, calibration, and/or special hardware, while at the same time keeping the potential of being operated in an interactive mode in a user-friendly way, or being operated as a completely automatic unsupervised rare event detection system. Due to these features, the device is suited to be applied to and operated in routine environments of small and mid-sized laboratories as a multi purpose system for accommodating small slide volumes of different natures, while at the same time also meeting the needs of large laboratories as a high-speed, high-throughput system focused on high volume applications and virtual slide scanning for biological slides. The system comprises a microscope device (see FIGS. 1 and 2) with built-in automation functionality, a motorized stage, a fast autofocus device, and an RGB progressive area scan camera. For automatic high volume routine slide processing the system includes an automatic handling device for a plurality of slides such as 50 slides or optionally 200 slides. The motorized microscope stage and slide handler are connected via a controller to a PC or other computer device. The PC is preferably a top end model with good processing power and well equipped with system memory. The camera is linked to the same PC via a frame grabber. A bar code reader facilitates the automatic data management and work flow.

Standard CCD video cameras adhere to the NTSC or PAL video norm, which is based on interlace technology. This means that 2 sequential images with half the resolution each (odd lines versus even lines) are assembled to a full image. NTSC uses 60 half images per second, PAL uses 50. If an image is taken with an interlaced camera of a moving target, the two half images are slightly different from each other due to the difference in time between the first and the second acquisition of the half images (see FIG. 3). This introduces a jitter in the resulting assembled full image, which renders the image unsuitable for quantitative evaluation. One solution to avoid this problem for scanning systems using interlaced cameras is the stop and go modus of operation, as described for example in Bacus et al. However, such a solution leads to impractically large scanning times, on the order of hours (scan for a full slide with a 20× objective) for higher resolution scans.

Recently, progressive area scan cameras with excellent color quality have become commercially available. These cameras acquire a full image at a time so that the introduction of an image jitter for moving objects is eliminated (see FIG. 4). Such cameras generally come with an integrated shutter function, which allows one to electronically adjust the exposure times within a wide range. This further allows one to optically freeze the movement of a passing object without expensive strobe illumination. As these cameras typically can acquire 60 full images per second, low cost continuous motion scanning is feasible.

The system configuration listed above can essentially be operated in 3 different ways:

Interactive operation: The system can be used like a regular routine microscope with additional quantification capabilities. The operator is able to move the motorized stage via a bicoaxial digipot (FIG. 5) in an interactive manner, just as any other manual microscope stage. The bicoaxial digipot simulates the typical way and feeling of operating a manual microscope stage by using a motorized stage equipped with angle encoders which keep track of the slide location coordinates as the stage is moved. Contrary to a line scan device, the progressive area scan camera allows one to capture and evaluate individual frames. As the microscope is equipped with a regular halogen or LED microscope illumination source, and not a strobing device, the operator can watch and select the objects of interest underneath the microscope and store, on demand, individual FOVs for quantitative evaluation. This is especially useful for fast quantitative assessment of marker expression in histological sections, e.g. for the breast cancer panel, where the pathologist quickly selects a small number of areas of interest underneath the microscope, grabs an image of each field of view, and then the system automatically creates a quantitative assessment of the marker expression and generates the final report. The whole evaluation of a slide done in this way takes, for example, less than a minute.

Automatic rare event detection and quantification: The second way of operating the system is in an automatic rare event detection mode. First, a slide is automatically moved onto the motorized stage via the slide handler and its bar code is identified. Objects of interest are automatically identified based on predefined criteria and a fast continuous-motion low-resolution scan of the region of interest (ROI). The ROI can be predetermined based on a priori knowledge, and is typically a part of a slide, a specific cell deposition area, defined through a preparation process (e.g. liquid based preparation), or the whole slide. Objects identified during this first scan are then automatically relocated and their images acquired at high resolution and displayed in an image gallery for local or remote pathologist review.

Virtual slide scan: The third mode relates to the acquisition and quantitative evaluation of ROIs which are larger than individual FOVs. This includes, maximally, the complete slide. In this mode, the motorized stage moves the slide in a continuous motion underneath the microscope. The shutter speed of the progressive area scan camera is set to an exposure time short enough to optically freeze the motion and avoid blurred images.

As the stage travels with constant velocity, images are continuously acquired by the camera in such a way that images of adjacent FOVs include a certain overlap area with respect to neighboring images. The size of this overlap is not critical as long as a certain minimum amount is present, so no sophisticated hardware alignment is needed. In a subsequent step, the image tiles are assembled with pixel precision into the overall image of the ROI using a combination of correlation and statistical error minimization procedures. The second procedure is particularly necessary to be able to correctly align image tiles, which do not contain enough information for the correlation procedure to be correctly performed, such as, for example, empty fields. The simple mechanics of the image acquisition method illustrates that the system is error-tolerant and robust, and is therefore well suited for routine service. Contrary to existing virtual slide scanning systems, the major workload of the process is the software-based alignment of image tiles. As such, it is dependent on the speed of the processor applied to the task. This part of the system will automatically grow faster with the general advancement of the PC.

The review of the acquired data is done locally or remotely using the viewing device described, for example, in U.S. Patent Application No. US 2003/0,210,262.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram schematic of an automatic-interactive hybrid microscopy system according to one embodiment of the present invention;

FIG. 2 schematically illustrates a perspective view of one example of an automatic-interactive hybrid microscopy system as shown in FIG. 1;

FIG. 3 schematically illustrates an image capture of a moving object performed with a standard interlaced CCD camera;

FIG. 4 schematically illustrates an image capture of a moving object with a progressive area scan camera according to one embodiment of the present invention;

FIG. 5 schematically illustrates a perspective view of a motorized microscope scanning stage implementing a bicoaxial digipot, for facilitating simulation of manual use of the stage, according to one embodiment of the present invention;

FIG. 6 is a detailed block diagram schematic of one example of an automatic-interactive hybrid microscopy system according to one embodiment of the present invention;

FIG. 7 is a flow diagram of the automatic rare event detection and quantification operational mode of an automatic-interactive hybrid microscopy system according to one embodiment of the present invention;

FIG. 8 is a schematic illustrating remote viewing and relocation capabilities of an automatic-interactive hybrid microscopy system according to one embodiment of the present invention;

FIG. 9 schematically illustrates a gallery of selected objects of interest and a demonstration of the object relocation capability of an automatic-interactive hybrid microscopy system according to one embodiment of the present invention;

FIG. 10 schematically illustrates a unidirectional scanning pattern (comb scan) capable of being implemented by an automatic-interactive hybrid microscopy system according to one embodiment of the present invention;

FIG. 11 is a schematic representation of an asynchronous image acquisition scheme capable of being implemented by an automatic-interactive hybrid microscopy system according to one embodiment of the present invention;

FIG. 12 schematically illustrates a collection of raw unmatched image tiles captured by an automatic-interactive hybrid microscopy system according to one embodiment of the present invention;

FIG. 13 schematically illustrates a correlation procedure of two adjacent image tiles within a single band, according to one embodiment of the present invention;

FIG. 14 schematically illustrates an image tile map produced using correlation techniques according to one embodiment of the present invention, showing regional merge results for the captured image tiles;

FIG. 15 illustrates a Tissue Micro Array as one example of a slide that may include several disconnected tissue areas or samples;

FIG. 16 schematically illustrates a shift between the x-positions of the first image tiles of two adjacent bands, between those bands, resulting from the asynchronous image capturing procedure implemented by certain embodiments of the present invention;

FIG. 17 schematically illustrates a composite virtual image formed from correctly aligned overlapping individual image tiles obtained by an automatic-interactive hybrid microscopy system according to one embodiment of the present invention;

FIG. 18 illustrates one example of a single contiguous completed virtual slide formed from overlapping individual image tiles obtained by an automatic-interactive hybrid microscopy system according to one embodiment of the present invention; and

FIG. 19 is a magnified view of a portion of the virtual slide illustrated in FIG. 18, indicated by the rectangular area shown in FIG. 18.

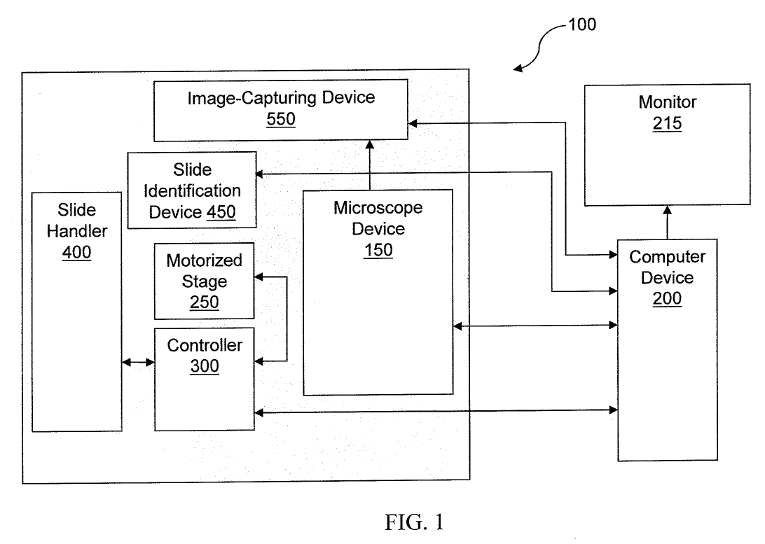

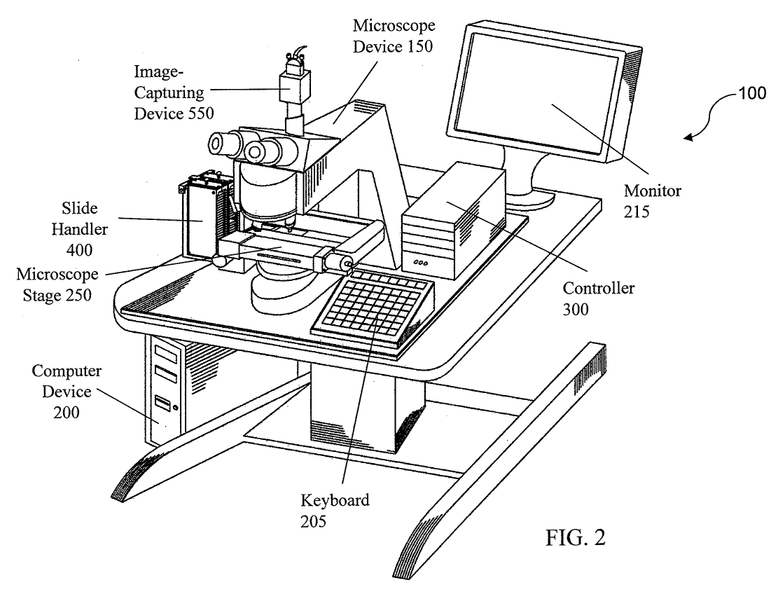

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

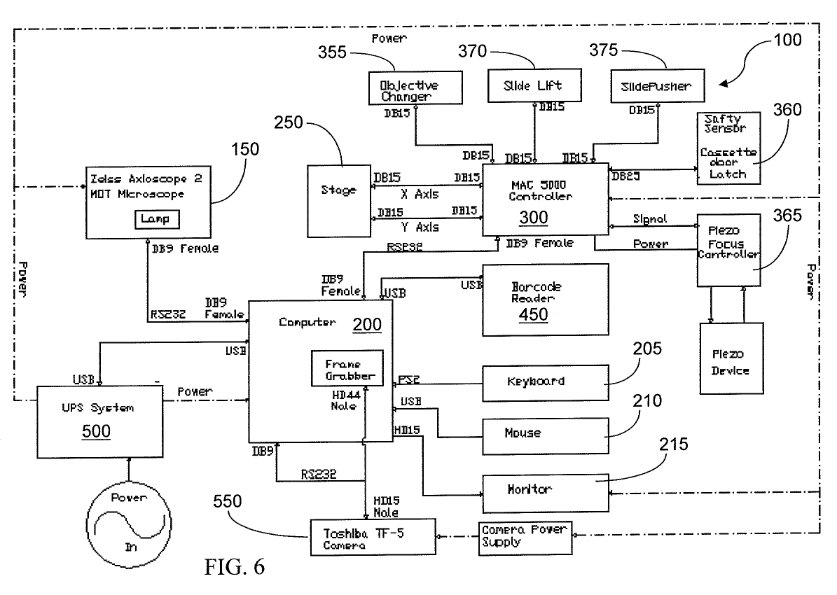

FIG. 6 shows a block diagram of one embodiment of an automatic-interactive hybrid microscopy system 100 according to the present invention. The system 100 includes a bright field microscope device 150 with automatic Köhler illumination. This means that the microscope illumination settings, such as light intensity and opening diameters of the condenser and field stops can be initially set and stored for each objective mounted on the microscope device 150 to provide optimal Köhler illumination when switching between different magnifications. One embodiment of such a microscope device 150 is, for example, the Zeiss Axioskop 2 MOT. The microscope device 150 is typically equipped with 5×, 10× and 20× Achroplan objectives. Other embodiments may have different objectives. The microscope device 150 is operatively connected to a computer device or processor 200, which allows one to control certain aspects of the microscope device functionality, such as, for example, the adjustment of the light source and the z-motion of the focus motor for coarse and fine focusing.

The microscope device 150 is equipped with a fast motorized scanning stage 250 with sufficient precision to allow reliable relocation of individual objects at different resolution levels. One embodiment is, for example, the Ludl Electronic Products Ltd. BioPrecision stage (speed with stepper motor 30 mm/sec, repeatability better 1μ). This stage 250 is controlled by a controller 300 such as, for example, the Ludl Electronic Products Ltd MAC 5000 automation control box which is operatively connected to the computer device 200 via an RS232 serial interface. The stage 250 is equipped with a dual coaxial digital potentiometer (digipot) drive 350 which allows for simulated manual control of the motorized stage 250 via directional motors 260, 270. In this way it is possible to switch between automatic computer-controlled stage movement and interactive stage control at any time without losing track of the coordinates of the stage position. Other components such as the objective changer 355 of the microscope device 150, safety sensors and the cassette door latch 360 of the system cover, the piezo focus controller 365, the slide lift 370 and the pusher 375 of the slide handler 400 (Ludl Electronic Products Ltd.) are operated through the MAC 5000 controller 300. The slide handler 400 holds, for example, 2 cassettes with 25 slides each, but can be upgraded, for example, to 8 cassettes with a total of 200 slides. It allows one to automatically move a slide from its original position in a cassette onto the scanning stage 250, and after the system 100 finishes the processing of the slide, moves it back into the cassette. The motorized objective changer 355 allows for computer-controlled automatic switching from one objective to another. The safety sensors and the system cassette door latch 360 are safety features integrated in the system 100 to provide hazard free interaction of the operator with the system 100. The piezo focus device 365 (PI piezo objective adapter, resolution 10 nm) complements the focus motor integrated in the microscope device 150 for fast fine focusing.

The different devices connected to the MAC 5000 controller 300 can be controlled by the software on the computer device 200 via an RS 232 connection between the controller 300 and the computer device 200. The computer device 200 consists of an off-the-shelf PC with preferably more than one processor for multithreading. It is equipped with a keyboard 205, a mouse 210, and flat panel monitor 215. A slide identification device 450 such as, for example, a barcode reader, is connected to the computer device 200 via a USB interface, and allows for automatic slide identification based on a bar code identifier associated with each slide. A UPS system 500 provides power for the system 100.

For image acquisition, the system 100 uses an image-capturing device 550, such as a video camera, mounted on the microscope device 150 in such a way that the analog image created by the microscope device 150 is projected onto the camera chip(s) within the camera 550. The camera 550 is operably connected with the computer device 200 via a camera interface. In order to accommodate the acquisition of individually-selected images in the manual mode of the system 100, as well as the fast automatic acquisition of images during the continuous-motion scanning of a slide, the camera 550 supports non-interlaced whole-frame image acquisition, in contrast to the regular interlaced PAL or NTSC standard video mode used by most CCD cameras.

Embodiments which fulfill the above requirements are progressive area scan cameras 550, such as, for example, the Toshiba IK-TF5 RGB 3CCD Progressive Scan camera, with excellent color quality, or a high-speed megapixel CMOS color camera (e.g. Mikrotron MC 1303) with a frame rate of up to about 100 frames/sec.

One particular embodiment of the system 100 implements the Toshiba IK-TF5 RGB progressive scan camera 550 with about a ⅓″ sensor size and an approximate pixel size of about 7×7 μm, operably connected with the computer device 200 via a frame grabber board 600 (Matrox Meteor), which allows an 8 bit digitization for each channel. In such instances, the camera 550 can use an image format, for example, of about 648×494 pixels.

The system 100 described above is configured to be operated in any of three different modes:

### 1) Automatic Rare Event Detection and Quantification Operation Mode

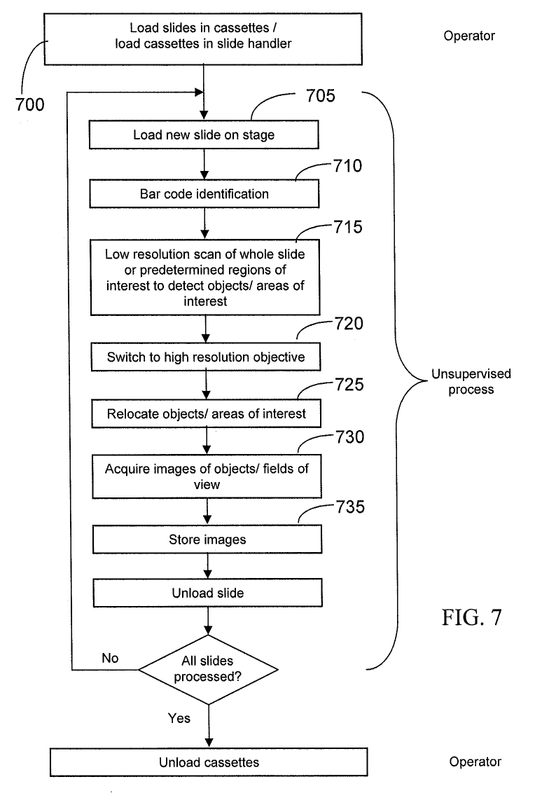

In this operational mode, the system 100 is configured to automatically find diagnostically-significant objects or fields of interest on the slide and present them in an image gallery for further visual interpretation and/or quantitative evaluation. This operational mode can be selected, for example, via the computer device 200 and/or the controller 300. In this mode, the system 100 can function with a minimum of operator interaction. FIG. 7 shows the system workflow. The slides which have to be processed are loaded in the cassettes of the slide handler 400 (block 700) and the system 100 is started. The first slide is automatically loaded on the scanning stage 250 (block 705) by the slide handler 400 and the bar code on the slide is read by the bar code reader 450 for positive slide identification (block 710). The complete slide or a predefined region of interest on that slide is then scanned at low resolution (block 715), typically using objectives with 5× or 10× magnification. The low resolution scan provides for automatic identification of objects and/or areas of interest for subsequent quantitative evaluation and/or human interpretation. The basis for the selection of objects and/or areas of interest is, in one embodiment, a chromogen separation procedure (e.g. U.S. Pat. No. 6,453,060, US 2003/0,091,221, US 2003/0,138,140), which allows different dyes to be digitally separated from each other in a live or stored (previously acquired) color image. This is of special interest for immunohistochemically and immunocytochemically stained slides. Objects or areas of interest with high marker expression labeled with a specific dye such as, for example, DAB, can be automatically detected and the corresponding location coordinates stored. Other embodiments rely, additionally or separately, on morphologic or other features to automatically identify objects or areas of interest for subsequent processing. When the low resolution scan is finished, the system 100 automatically switches to a high resolution objective (block 720), such as, for example, an objective with 20× or 40× magnification. Based on the location coordinates stored during the low resolution scan, the identified positions are then automatically relocated (block 725), field by field or object by object, a high resolution image is acquired (block 730), and the object(s) and/or area(s) of interest within each field quantitatively evaluated. The high resolution images are stored (block 735) for later display in an image gallery 900.

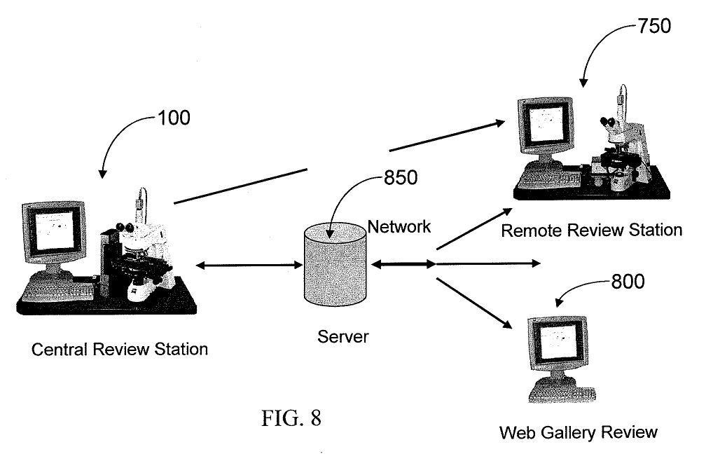

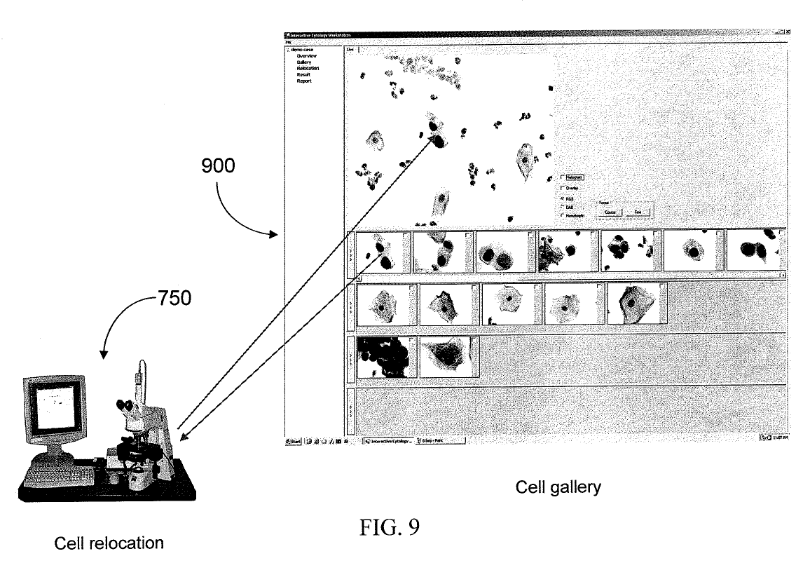

In one embodiment, the image gallery 900 is presented on a separate interactive review system, such as a review station 750 or a gallery reviewer 800, connected via a network/over a server 850 to the scanning device (system 100, as previously described (see FIGS. 8 and 9).

### 2) Interactive Operation Mode

The system 100 can also be configured to operate in an interactive manner, through selection, for example, via the computer device 200 and/or the controller 300. For this purpose, a progressive area scan camera 550, for example, is used for fast scanning, as required in the rare event and virtual slide mode, but which also provides whole individual images as needed in the interactive mode. Such a configuration avoids the use of special high-precision hardware and strobe illumination in the interactive mode, but, as a consequence, requires the system 100 to implement more sophisticated software procedures to compensate for the simplicity of such a configuration, as will be discussed in further detail below with respect to the virtual slide scanning operation mode.

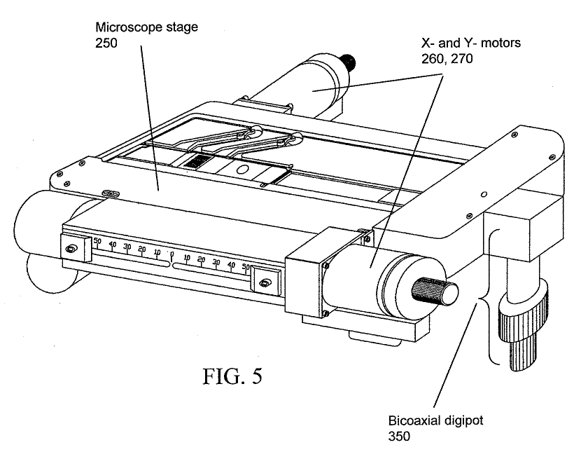

The interactive operation mode allows the user to select, via the system 100, the objects or areas of interest for review. A slide is loaded automatically onto the stage 250 via the slide handler 400 and the slide bar code is identified. The selection of the fields or objects of interest is now entirely up to the operator. Moving the slide manually underneath the microscope objective via the bicoaxial digipot device 350 (see FIG. 5), the operator can select and acquire any field of view which is expected, by the operator (subjective evaluation), to be of diagnostic interest. The bicoaxial digipot 350 simulates the operational method, and the tactile sensation associated therewith, of a manual microscope stage, by using a motorized stage 250 equipped with angle encoders (not shown) which keep track of the slide location coordinates as the stage 250 is moved. The images acquired by the image acquisition device 550 are quantitatively evaluated and the results, along with the selected fields of view, are saved and presented on the monitor 215 for review.

The interactive operation mode also allows the system 100 to be used as an interactive review station 750 (i.e., includes the same interactive review capabilities as the interactive review station 750) for the initial scan results acquired with the automatic rare event detection mode described above. In that case, as soon as the bar code of a slide is read, where that slide has been processed before in the automatic rare event detection mode, the system 100 pulls the initial scan results from the database on the computer device 200, wherein such a database may be located on a remote server 850, and displays the initial scan results as an image gallery 900 on the monitor 215. In either instance, the user can then derive and/or determine a diagnosis of the slide based on the visual interpretation of the image gallery 900 alone, or with the support of quantitative measurement results. Objects or fields of view (areas of interest) which are presented in the image gallery 900 can also be automatically relocated per a mouse click on the corresponding image. In such an instance, the computer device 200, the slide handler 400, and the stage 250 can cooperate to bring the selected object(s) or area(s) of interest into the field of view of the microscope device 150. If the images were initially acquired from ICC or IHC slides based on the amount of marker expression in the corresponding fields of view, the sequential relocation of the different objects and areas of interest allow the user to quickly step through a number of slide locations which were initially selected by the automatic scanner for their significant marker expression. This process is referred to, in some instances, as “Marker Guided Screening”.

### 3) Virtual Slide Scanning Operation Mode

In this operational mode, the system 100 is configured to acquire, as an end product, a single large overview image of the whole slide or of a predefined area of the slide, possibly at different optical resolutions, for visual inspection or subsequent quantitative evaluation. This overview image is at least as large as the individual FOVs seen under the microscope device 150.

In contrast to prior art devices for virtual slide scanning, embodiments of the disclosed invention combine continuous high speed scanning—versus a “stop and go” operation for prior art devices—with an image capturing device 550 configured to grab whole images—versus individual lines for prior art devices—without using high-precision hardware and/or special illumination devices, such as strobe lamps. In this manner and configuration, the interactive operation mode of the system 100 can thus be maintained on the same platform using the same hardware.

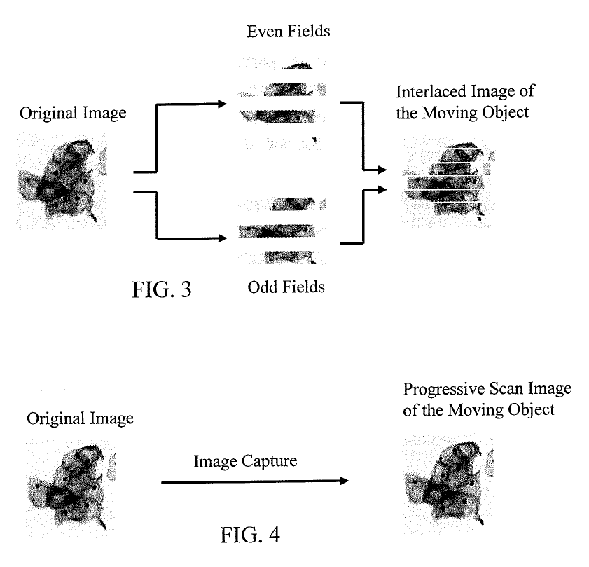

In furtherance of such capabilities, embodiments of the present invention include an image-capturing device 550 comprising a progressive area scan camera. Progressive area scan cameras do not use the standard interlace video technology and, consequently, are not susceptible to a reduction of image quality as result of “image jitter.” Typically, such image jitter is due to the fact that during fast scanning stage and/or slide movement, the two corresponding interlace half images are acquired at slightly different locations and cannot form one consistent image (see, e.g., FIG. 3 and accompanying discussion).

The output of a progressive area scan camera 550 is a complete image frame at a particular time, in contrast to the line output of a line scan camera. This feature is essential to support the operational modes of the system 100 described above. Other non-interlaced camera technologies such as, for example, CMOS cameras, are equally well suited for use in the system 100 and are considered to be within the spirit and scope of the present invention.

In one embodiment, the image-capturing device 550 comprises a Toshiba IK-TF5 RGB progressive scan camera with about a ⅓″ sensor size and a pixel size of about 7.28μ×7.28μ. Accordingly, such a configuration is used hereinbelow to illustrate the acquisition and generation of a virtual slide according to one embodiment of the present invention.

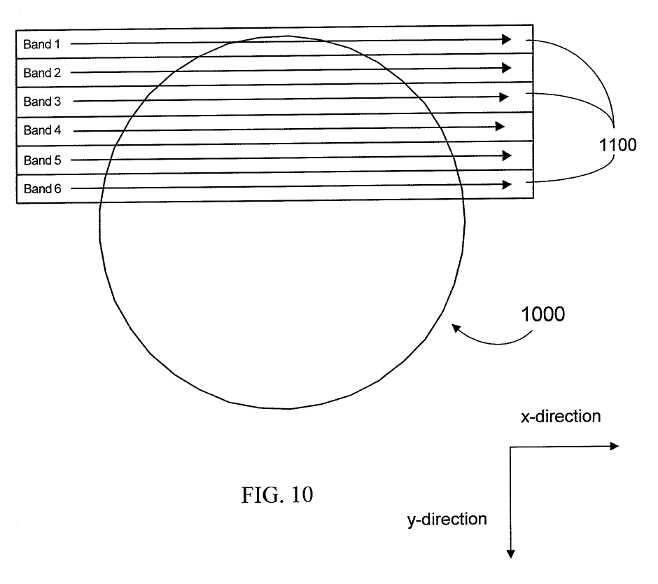

In the virtual slide scanning operation mode, the scan area 1000 is divided into adjacent bands 1100 to be continuously scanned. In one embodiment, the system 100 is configured to perform automatic screening of the cell deposition area of a liquid-based TriPath SurePath slide with a circular cell deposition area of about 13 mm diameter. Accordingly, a method associated with virtual slide scanning will be explained using the example of a 13.5 mm×13.5 mm scanning area 1000 (see, e.g., FIG. 10). Though a method is described herein in terms of a particular slide configuration, one skilled in the art will appreciate that such a configuration is for exemplary purposes only and that such a method is not limited to any specific scan area, and other areas of the slide such as, for example, the whole slide are also included within the scope of the present invention.

Contrary to a line scan procedure, the progressive scan camera 550 captures, generates, and outputs whole image frames, instead of individual lines. The disclosed invention uses such a camera 550 in an asynchronous mode, where it continuously grabs images at a selected interval, while the microscope stage 250 is moving at a substantially constant speed. That is, at certain time intervals, an image grabbed by the image-capturing device 550 is stored, for example, by the computer device 200. The time intervals are chosen in such a way that the individual stored images combine to form and cover the whole band 1100 along the slide, with sufficient overlap between adjacent images in the band 1100, such that the images can then be merged with pixel precision, using correlation-based procedures, wherein such procedures may be implemented in software, hardware, or a combination of software and hardware.

The width of each band 1100 is defined by the y-dimension D_{y} of the camera sensor/chip, the magnification factor M of the selected microscope optics creating the analog image on the camera chip, and a chosen overlap area O_{y} between two adjacent bands 1100 necessary for the correct alignment of the bands 1100 to form a complete image. The x-direction is defined in this example as the direction in which the stage 250 moves during the process of acquiring images (scan) used to create a complete band 1100, and the y-direction is orthogonal to the x-direction within the object plane (see, e.g., FIG. 10).

Depending on the level of detail required in the virtual slide produced by the system 100, the band scans can be done with objectives of different magnification and resolution. Objectives with low magnification factors, such as 2.5×, 5×, or 10×, typically display low resolution characteristics and a relatively large focal depth. Other embodiments may use, for example, additional optics (optovars) of magnification factors 1.25×, 1.5×, 2× or similar to create new total magnification factors which are derived from the multiplication of the magnification factor of the objective and the following optovar.

To automatically keep the images focused, relatively simple focus strategies can be applied based on, for example, a one point or a three point focus map to allow for the adjustment of any slide tilt. Higher magnification objectives (e.g., 20× and higher) generally require a more sophisticated focus map based on a larger number of seed points.

Given a scan area S with dimensions x and y,

S=x·y

the number of bands N_{band} needed to cover the area S, as depicted in FIG. 10, is defined as:

$${N}_{band} = \frac{M \cdot y}{{D}_{y} \cdot ( 1 - \frac{{O}_{y}}{{N}_{y}} )}$$

Using the example of a scan applying an objective with magnification M=5 to cover a scan area with dimensions x=13.5 mm and y=13.5 mm, with a typical overlap between adjacent bands of O_{y}=40 pixels, and the Toshiba IK-TF5 RGB progressive scan camera 550 acquiring the images with camera chip having a dimension in the y-direction D_{y}=3.6 mm and a pixel resolution of Nₓ×N_{y}=659×494 pixel, the number of bands necessary to cover the scan area is 21 bands. Under such constraints, one skilled in the art will readily appreciate that changes in most any of the variables may significantly affect the performance of the system 100. For example, if a ⅔″ camera chip is used in the image-capturing device 550, the number of bands is cut in half.

The bands 1100 can be scanned in either a unidirectional or a bi-directional pattern. A band 1100 is scanned at a substantially constant speed ν_{stg} and images are captured at defined time intervals T_{acqu} to capture the images necessary to build the band 1100. Due to the nature of the progressive scan camera (non-interlaced image acquisition), it is not necessary to stop the scan that the time each image is acquired so as to avoid “image jitter”. However, the speed of the stage 250 and the exposure time Tₑₓₚ, during which the camera chip is exposed to the analog image created by the microscope optics, should be carefully selected to avoid reduction of image resolution in the direction of the stage movement.

Tₑₓₚ can be adjusted through the electronic shutter of the camera 550. The shutter allows one to limit the exposure of the camera chip(s) to the analog image to a well-defined exposure time, which, in the example, can be set in a range from about 1/500 sec to about 1/10000 sec. The exposure time, also referred to herein as “shutter speed,” and the travel speed of the microscope stage 250 should be configured such that the stage 250 is able to move as fast as possible in the selected scan pattern without blurring the captured images that are acquired during the scan procedure.

In some instances, any pixel blurring can be neglected if, during the generation of the image information in the camera chip, the image details do not move more than a distance of about half a pixel P. With this restriction, the maximum scan velocity of the microscope stage ν_{stg} can be computed for a given exposure time Tₑₓₚ and magnification M:

P=Tₑₓₚ·ν_{stg}·M

From this the maximal stage speed can be calculated according to the formula

$${v}_{stg} = \frac{P}{{T}_{exp} \cdot M}$$

With a pixel size for the Toshiba TF-5 RGB progressive scan camera 550 of about 7.28μ, P=0.5·7.28μ in the x- and y-directions, magnification M=5, and an exposure time Tₑₓₚ of 1/10000 sec, the maximum acceptable stage scanning speed is about 7.28 mm/sec. If the stage is moving faster than ν_{stg}, a blur will be visible in the resulting image.

The use of extremely short exposure times Tₑₓₚ for the camera 550 is limited by the amount of light which is available at various magnifications. Objectives with higher magnification factors, such as a 10× or 20× objective, may need longer exposure times Tₑₓₚ. At a 5× magnification, the scanning stage 250 has the potential to go approximately 2× faster (exposure time) than the 10× x or higher objective. However, in either case, image blur would likely occur. In order to remedy this problem, since the stage speed is known and substantially constant, certain methods [e.g. Russ] can be applied to remove motion blur from the captured images.

Contrary to a line scan camera, each of the bands 1100 in the disclosed invention is created out of a number of adjacent and overlapping whole image frames individually captured by the image-capturing device 550. The individual images are acquired at regular time intervals T_{acqu} with a preset overlap Oₓ. The overlap has to be large enough that 2 adjacent images can be merged together with software, hardware, or a combination of software and hardware, and with pixel precision using correlation-based procedures. As discussed, such a system 100 of the present invention does not rely on any special hardware for abutting two adjacent image tiles with pixel precision, as disclosed by Bacus et al. (U.S. Pat. No. 6,101,265; U.S. Pat. No. 6,272,235) and/or Wetzel et al. (US 2002/0090127),

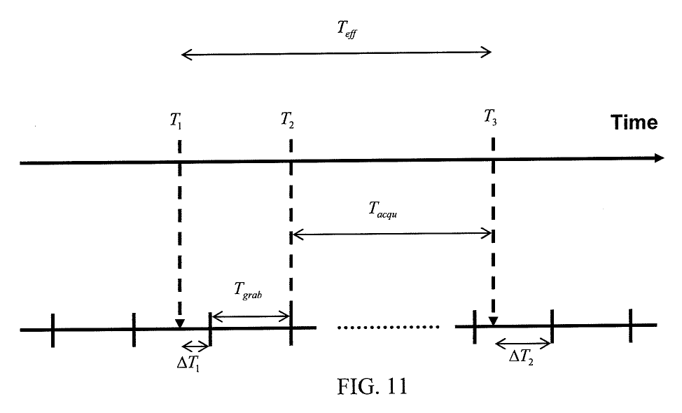

The time interval for image capture (see, e.g., FIG. 11) is defined as

$${T}_{acqu} = \frac{{P}_{x} \cdot {N}_{x} \cdot ( 1 - \frac{{O}_{x}}{{N}_{x}} )}{M \cdot {v}_{stg}}$$

Given the numbers of the above example, namely a pixel size Pₓ=7.28μ, number of pixels of the camera 550 in the x-direction Nₓ=659, magnification factor of the objective M=5, stage speed ν_{stg}=7.3 mm/sec, preset overlap Oₓ=100 pixel, T_{acqu} for such an example computes to T_{acqu}=112 msec.

Since embodiments of the disclosed invention do not use a real-time operating system, or a more generic hardware trigger, in the system configuration, the time between 2 subsequent image acquisitions by the image-capturing device 550 may actually vary throughout an image acquisition cycle. For example, in one embodiment, the Toshiba TF-5 camera 550 is configured to grab 60 frames/sec, which leads to a cycle time of approximately 17 msec per frame. In order to generate a band 1100, the microscope stage 250 moves at a substantially constant speed, only stopping when the predefined length of the dimension of the scan area 1000 in the selected scan direction is reached. During the entire scan, the camera 550 grabs images at 60 frames/sec. If, at time T₁, the application software sends a command via the computer device 200 to acquire an image, the ongoing image grab cycle of the camera 550 must be finished first. This leads to a small additional delay time ΔT₁ before the next image can be acquired. The acquisition process of this next image is finished after a time T_{grab} at time T₂. The application software, executed via the computer device 200, then stores that image. The application software, executed via the computer device 200, then waits for a certain time T_{acqu}, starting at T₂, until the next grab command is issued (T₃). As the camera 550 continues to grab images during the waiting time, in an asynchronous mode, the camera 550 may thus end up in a different part of the image grab cycle when the next image grab command is issued. This may lead again to an additional delay ΔT₂, which may be different than the delay ΔT₁ during the previous image grab. Again the current image grab cycle gets finished before the newly triggered image can be acquired and stored, as previously described.

Therefore, the effective time between the acquisition and storage of 2 subsequent images is

T_{eff}=T_{acqu}+T_{grab}+ΔT

with ΔT≦17 msec, depending on when the image acquisition command was issued in relation to the camera grab cycle. This may decrease the overlap Oₓ by up to 85 pixel in the given example.

Another embodiment of the invention includes a manner of externally triggering the camera 550 to start the grab cycle at particular time intervals. In such a case, the uncertainty ΔT is reduced to the precision of the generated trigger signal.

The number of images per band can be computed as follows:

$${N}_{images} = \frac{M \cdot x}{{N}_{x} \cdot {P}_{x} \cdot ( 1 - \frac{{O}_{x}}{{N}_{x}} )}$$

Inserting the numbers of the above example, namely, the objective with magnification factor M=5, the x-dimension of a band x=13.5 mm, the number of pixels of the camera 550 in the x-direction Nₓ=659, a pixel size Pₓ=7.28μ, and a preset overlap Oₓ=100 pixel, N_{images} computes to N_{images}=17 images per band.

After each band 1100 is scanned, the bands 1100 are then combined by using the overlap information O_{y} to merge the bands 1100 together with pixel precision to create the final image (virtual slide) of the whole scan area.

Depending on the chosen magnification of the scan optics and the resulting amount of data, as well as the available memory resources, images of a band 1100 or of a whole scan area can be kept in memory, for example, in the computer device 200 or the server 850, to allow for online processing. If a second processor is available, the merging of the images will be processed in a second thread while the scanning thread continues to acquire images with the highest priority to provide fast and reliable image capture.

To calculate the total time for a slide scan, an additional acceleration time T_{acc} and—if unidirectional scanning is used—an additional return time per band to move the stage 250 back to the beginning of the next band must be included in the calculation. The return movement of the stage 250 typically is done at the maximum stage speed ν_{stg max}. T_{acc} is the time needed to accelerate the motorized microscope stage 250 to the selected scan speed ν_{stg} outside of the scan area 1000, so that the image acquisition inside the scan area 1000 can be done at constant speed right from the beginning (that is, the stage 250 is accelerated to the scan speed prior to entering the scan area 1000). The total time needed to scan and acquire the images for a virtual slide of a scan area 1000 of dimensions x·y can thus be calculated as follows:

$${T}_{scan} = {N}_{band} \cdot [ {T}_{acc} + {N}_{image} \cdot {T}_{acqu} + \frac{( x + \frac{y}{{N}_{band}} )}{{v}_{stg max}} ]$$

Using the example of one embodiment with the number of bands covering the scan area N_{band}=21, a typical acceleration time per band of T_{acc}=150 msec, a number of images per band of N_{images}=17, an acquisition time T_{acqu}=112 msec, a scan area with the dimensions x=13.5 mm and y=13.5 mm, and a maximal stage speed of ν_{stg max}=15,000 μ/sec, the total time needed for scanning the entire scan area 1000 computes to T_{scan}=63 sec.

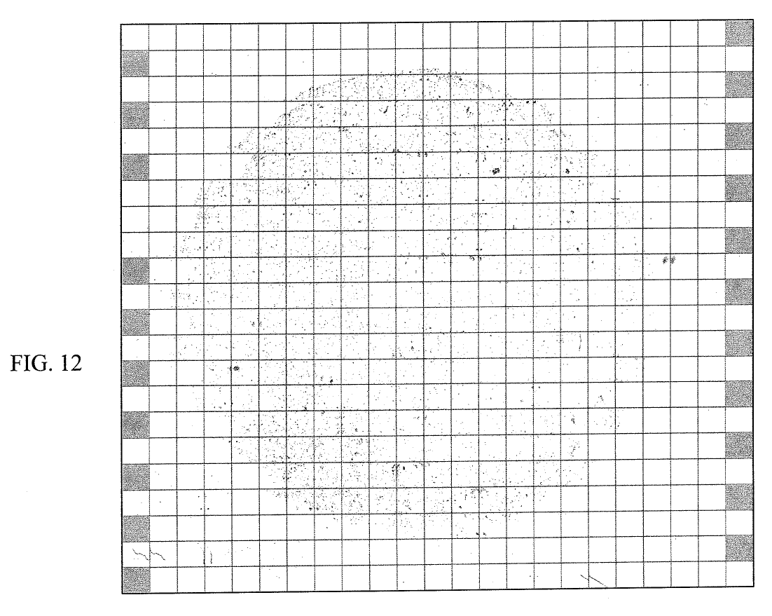

Once the individual images tiles of a slide scan are acquired (see, e.g., FIG. 12) the tiles are merged together to form one large contiguous and seamless virtual slide. Since the image tiles are not collected relying on high precision hardware, which would allow a simple abutting of tiles as described by Bacus et al. (U.S. Pat. No. 6,101,265; U.S. Pat. No. 6,272,235) and Wetzel et al. (US 2002/0090127), but instead comprise a plurality of overlapping images, the present invention further comprises a method based on software, hardware, or a combination of software and hardware, executed by the computer device 200 to form the seamless, contiguous, high-quality virtual slide image.

As a first step, the system 100 attempts to correlate each non-empty image within the first band with its immediately adjacent (i.e., left and right) neighboring images. The correlation procedure relies on the presence of the overlap area between any two adjacent images. A particular image tile is considered to be empty if it primarily exhibits empty background information and no part of a histological section, cell clusters, cells or other objects. Image tiles meeting the correlation criteria and exhibiting successful correlation results then get merged into the respective band.

The correlation procedure can be based on, for example, either a Fast Fourier Transformation (FFT) technique or on a convolution method. Both methods are considered as being within the scope of the present invention. The FFT method has performance advantages in instances where little or nothing is known about the image tiles to be correlated.

In one embodiment of the invention, however, a priori knowledge of the image tiles in terms of, for example, the average effective x- and y-tile dimensions, variances thereof, and the tile overlap, is available. In such instances, the convolution method can be used. The average effective x- and y-tile dimensions are the average dimensions of hypothetical tiles that would cover the merged and connected areas, in a seamless, contiguous, and complete manner, if the image tiles were simply abutted.

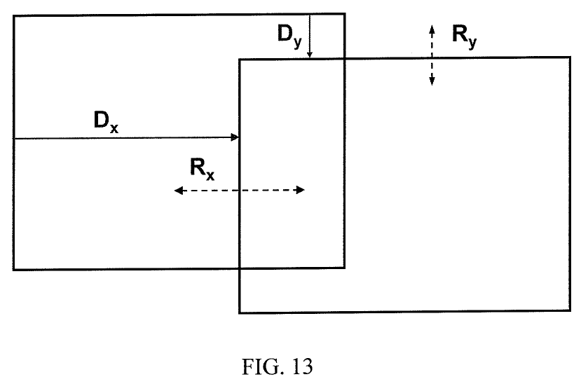

To correlate two adjacent images within a band, the correlation procedure is initiated at an estimated start position D(x,y) with a limited search range R(x,y). For the estimated initial start position within each image tile, the coordinates x and y are empirically chosen in the same range as the average effective x- and y-tile dimensions (see, e.g., FIG. 13). The dimensions of the search range R(x,y) are empirically derived from the average dimensions of the overlap areas of the image tiles in x- and y-direction plus an added margin.

To speed up the virtual image formation process, the correlation procedure is first performed on sub-sampled images (i.e., using only every Nₓth and N_{y}th pixel). This leads to a first coarse correlation result which, in turn, is used as a starting point for a more accurate correlation with a smaller search range and less sub-sampling.

This process is iteratively repeated as follows:
1. Correlate neighboring image tiles with starting point D(x,y) and with a limited range R(x,y) using only every Nₓth and N_{y}th pixel to produce a correlation result (i.e., a correlation coefficient, as will be appreciated by one skilled in the art).
2. Use the point with the highest correlation (result or coefficient) as a new starting point. Set search range R(x,y) to (±Nₓ, ±N_{y}). Use

$$\frac{{N}_{x}}{2} and \frac{{N}_{y}}{2}$$

as new values for Nₓ and N_{y}.
3. Repeat until Nₓ and N_{y} equals 1.
4. If the correlation result or coefficient is above a given threshold (for example, 0.9), accept the match. If not, consider the image tiles as uncorrelated.

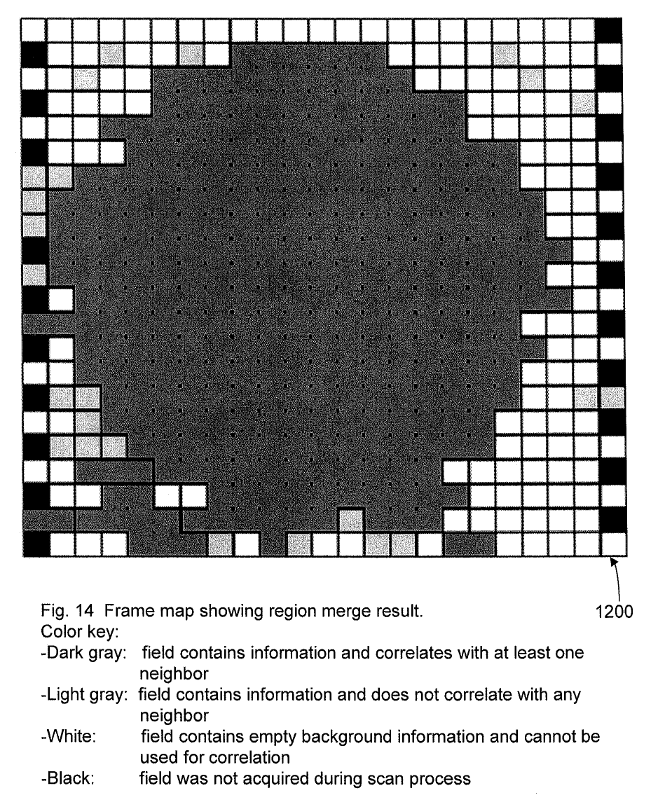

A band 1100 may be comprised of several smaller stripes of varying lengths. In one extreme case, the whole band may comprise a single stripe, while in another extreme case, the band may comprise a sequence of individual uncorrelated images (see, for example, the last band 1200—the bottom-most horizontal band—in FIG. 14). Once the stripes in two adjacent bands are created, the system 100 then attempts to correlate the stripes of the first band with the stripes of the second band (i.e., perpendicular to the directions of the bands) to merge the bands into connected areas.

In this regard, the system 100 starts with the first stripe in the band and attempts to correlate that stripe with the first stripe of the next adjacent band. Since the scan parameters are fairly consistent between bands, the variance in location between bands in the y-direction (perpendicular to the scan direction) is relatively small. As such, the y-dimension of the search range in the cross-band correlation procedure can be kept relatively small.

The variance in x-direction (scan direction), however, can become quite large in some instances due to the accumulated and inherently larger uncertainty in x-direction due to the implemented image acquisition procedure, as previously discussed. For instance, the variance may even extend to more than one frame width in some instances. Therefore, the search range in the x-direction, in one embodiment, extends over the full x-dimension of an image tile. If no match can be found between two image tiles at the same x-position in neighboring bands in the y-direction, the search is then extended to one image tile to the left and to the right of the initial image tiles. This extension of the search range in x-direction may even be further increased to a predetermined maximum number of frames to the left and right in particular cases.

If two correlated image tiles in neighboring bands are found, all connected image tiles in both bands are merged into one larger area, and correlation of subsequent frames of the same area may be skipped to expedite the image formation process. The process of correlating and merging image tiles within single bands into stripes, to correlating and merging stripes of adjacent bands into connected areas, is repeated until all of the images of a slide scan are processed.

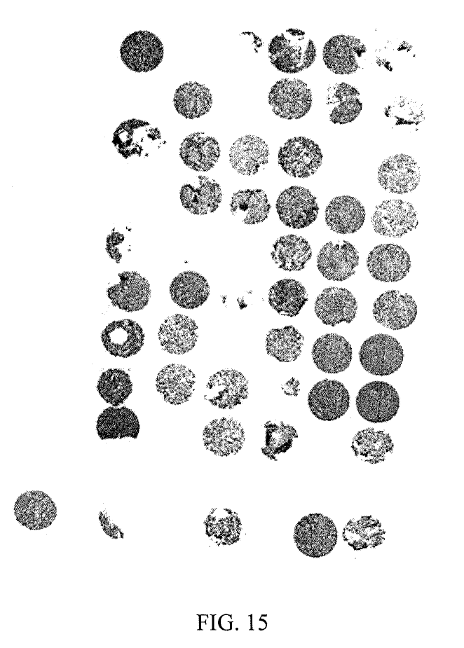

Microscopic cytology or histology preparations often include more than one cell deposition area or tissue section on the same slide. One example is a tissue micro array, which generally includes several small tissue areas (cores) on one slide (see, e.g., FIG. 15). These areas are not connected with each other, and are separated by “empty background.” Images with empty background information cannot be used for correlation purposes and are excluded from the merge process, as described above. The only useful information, which the system 100 retains in that case, is the number of empty fields between non-empty fields, as indicated by the image index.

Empty fields subjected to the merge process results in a number of areas, wherein each area itself was properly created from merging a large number of image tiles, but where the areas themselves cannot be connected via correlation to the final virtual slide because of the missing information in between. This problem may be worsened by the fact that the effective contribution in the x-direction of each image tile to the final virtual slide varies in an unknown way because of the variation in the overlap area caused by the asynchronous image acquisition through the camera 550.

To be able to generate the virtual slide in such instances, the following method is applied: From the correlation data obtained during the merge process, the average effective x- and y-tile dimensions are first determined. These are the average dimensions of hypothetical image tiles that would cover the merged connected areas, found via the correlation and merge process, in a seamless, contiguous, and complete manner, if such hypothetical image tiles were simply abutted. The x-tile dimension is determined as an average within each band i as x̅ᵢ, and the y-tile dimension is determined as average over all bands as y̅. The variation in the y-direction is determined by the overlap area between the bands, which is defined by the precision of the scanning stage 250 and the scanning procedure for the slide. The variation in the x-direction, however, is a consequence of the asynchronous method of acquiring the images, and is therefore generally less well defined. Situations may occur where, within a single band, none of the image tiles can be correlated. For example, such non-correlation situations may occur if most of the image tiles contain empty background information. For these cases, no effective x-tile dimension can be determined based on the average x̅ᵢ of that band, and the average x-tile dimension value x̅ computed from all bands is therefore used instead.

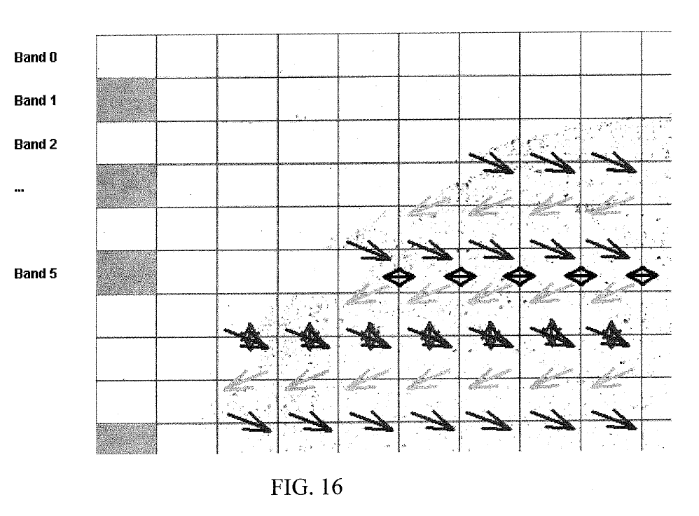

When the images of two adjacent bands are being acquired during the slide scan procedure, both bands preferably start at the same x-position. If the images in each band are indexed from left to right (for a scan with a “horizontally-disposed” scanning scheme) with 1 to N, images with the same index in both bands ideally should start at the same x-positions. Due to the asynchronous camera operation, however, there is the uncertainty of up to one image tile cycle of when the first image is actually acquired. This uncertainty may be more pronounced if, instead of scanning only in one direction, for example, from left to right (i.e., a comb scan), the scan direction is reversed between two bands. Such a situation may occur where a meander scan technique is applied, with the scan thus being performed alternatingly from left to right and from right to left. Both scenarios lead to a shift between the x-positions of the first image tile of either band between the adjacent bands (see, e.g., FIG. 16). This shift or x-offset is determined between each pair of adjacent bands in the virtual image formation process. In cases where the offset could not be determined due to lack of correlation between the stripes of the two adjacent bands, the average x-offset of either the odd bands or the even bands can be used instead, depending on whether the band has an odd or an even number.

Once the effective image tile dimensions per band, the image tile positions within the band, the x-offset between adjacent bands, and the image indices per band (which also count empty background images) are known, a grid of the best estimate x- and y-coordinates for each image tile is computed to form a basis for assembling the final virtual slide.

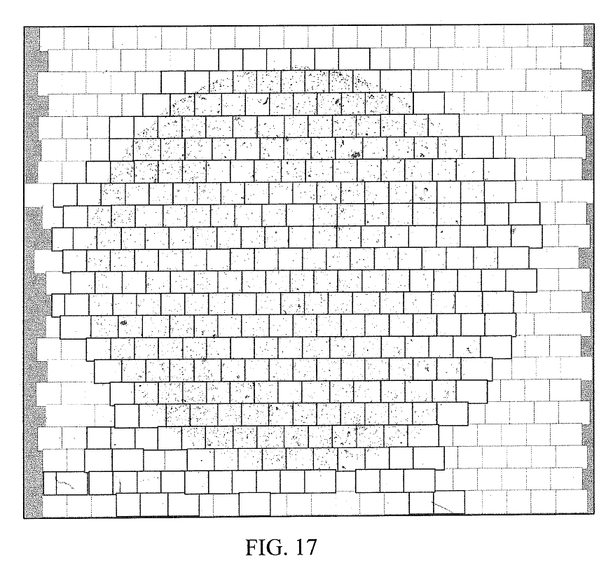

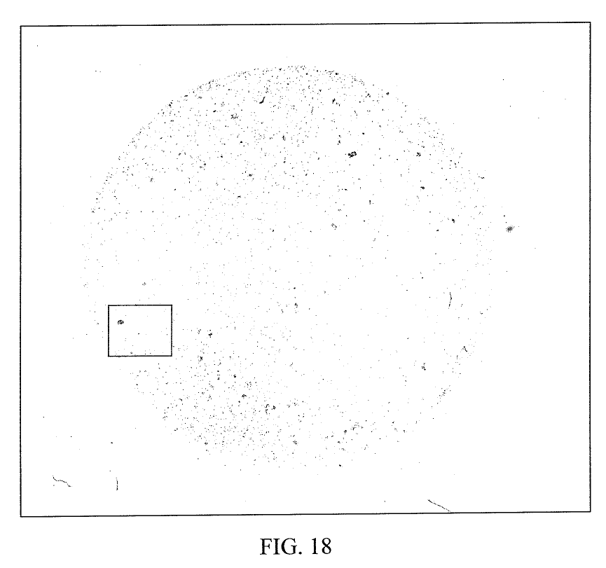

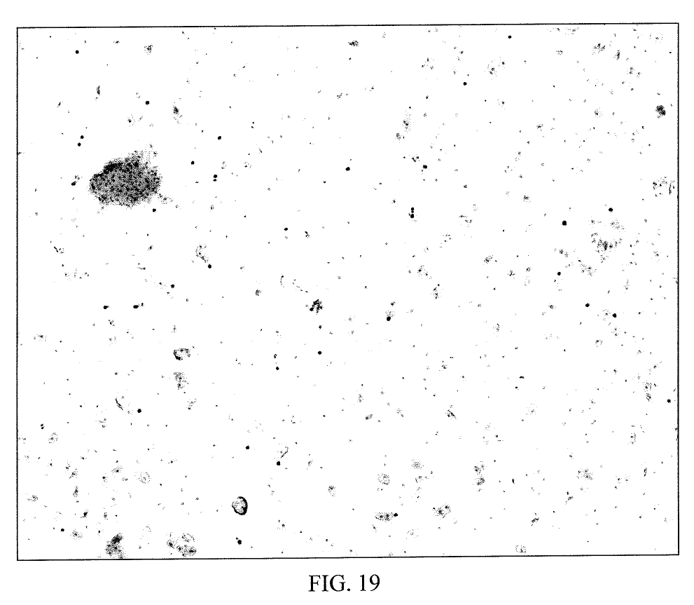

The first step to create the virtual slide comprises generating a white, generally rectangular image having x- and y-dimensions derived from the smallest and largest x- and y- best estimate coordinates. Empty fields and singular, unconnected fields are first placed into the grid at their respective calculated locations. Connected areas, which were created during the initial merge process, are then sorted in ascending, order according to the number of image tiles forming each connected area. The images/image tiles of these areas are then placed into the grid, starting with the smallest area and ending with the largest area. Since the grid coordinates are based on the average effective tile dimensions, the calculated and the real positions of the image tiles of these connected areas may be slightly different. For that reason, connected areas are placed into the grid by “centering” those areas around their grid locations. That is, the final grid positions of the tiles of a connected area are determined by minimizing the mean square error of the grid positions based on the average effective tile dimensions and the grid positions based on the real dimensions of the image tiles of the particular connected area. The resulting image is a virtual slide with all the image tiles seamlessly aligned with pixel precision (see, e.g., FIGS. 17-19).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of creating a virtual slide, comprising:
continuously capturing a plurality of discrete images of respective portions of a slide with an image capturing device configured to capture each image as a discrete multi-pixel area representation of the corresponding portion of the slide;
scanning the slide with the image capturing device, commensurately with capturing the plurality of images of respective portions of the slide, in a first scan direction along the slide such that successive images of the plurality of images overlap by a first selected number of pixels in the first scan direction and form a first scanning band;
scanning the slide with the image capturing device, commensurately with capturing the plurality of images of respective portions of the slide, in a second scan direction along the slide such that successive images of the plurality of images overlap in the second scan direction and form a second scanning band, the slide being scanned in the second direction such that the second scanning band overlaps with the first scanning band by a second selected number of pixels; and
combining the overlapping plurality of images in the first and second scanning bands so as to form a single contiguous virtual image of the portions of the slide scanned by the image capturing device.

2. A method according to claim 1 wherein scanning the slide with the image capturing device in a second scan direction further comprises scanning the slide with the image capturing device in the second scan direction along the slide, the second scan direction being the same as the first scan direction, such that successive images of the plurality of images overlap in the second scan direction and form a second scanning band.

3. A method according to claim 1 wherein scanning the slide with the image capturing device in a second scan direction further comprises scanning the slide with the image capturing device in the second scan direction along the slide, the second scan direction being opposite the first scan direction, such that successive images of the plurality of images overlap in the second scan direction and form a second scanning band.

4. A method according to claim 1 wherein combining the overlapping plurality of images further comprises applying a correlation procedure to the overlapping plurality of images so as to merge the overlapping plurality of images into the single contiguous virtual image.

5. A method according to claim 4 wherein applying a correlation procedure further comprises applying a correlation procedure implementing at least one of a Fast Fourier Transformation technique and a convolution technique.

6. A method according to claim 4 wherein applying a correlation procedure further comprises:
correlating a first subset of images selected from the plurality of images to determine a first correlation result, the first subset being spaced apart through the plurality of images and having a first resolution;
correlating a second subset of images selected from the plurality of images, based upon the first correlation result, to determine a second correlation result, the second subset being less spaced apart through the plurality of images than the first subset and having a second resolution greater than the first resolution; and
iteratively correlating subsequent subsets of images based upon the previous correlation result, each subsequent subset being less spaced apart through the plurality of images than the previous subset and having a greater resolution than the previous subset, until the resolution of the subsequent subset is at least equal to a selected virtual image resolution.

7. A method according to claim 6 wherein applying a correlation procedure further comprises applying a correlation procedure to the overlapping plurality of images such that two adjacent images are correlated if a correlation result resulting from the correlation procedure therefor exceeds a selected threshold.

8. A method according to claim 6 wherein applying a correlation procedure further comprises applying a correlation procedure to the overlapping plurality of images so as to merge adjacent images into a stripe, the stripe comprising a portion of a band.

9. A method according to claim 8 wherein applying a correlation procedure further comprises applying a correlation procedure to the overlapping plurality of images so as to merge adjacent stripes in adjacent bands into a connected image.

10. A method according to claim 1 further comprising determining an average image dimension at least one of along one of the scanning directions and perpendicular to the one of the scanning directions.

11. A method according to claim 1 further comprising determining an average image dimension at least one of parallel to the scanning directions and perpendicular to the scanning directions for the single contiguous virtual image of the portions of the slide scanned by the image capturing device.

12. A method of forming a virtual slide from a plurality of images comprising a plurality of discrete groups of merged and connected images spaced apart from each other by a plurality of non-correlatable and unmergeable images, comprising:
forming a grid of best estimate orthogonal coordinate pairs for each of the plurality of images, based on an average effective image dimension;
placing each of the non-correlatable and unmergeable images onto the grid at a position corresponding to the best estimate coordinate pair therefor;
sorting the groups of merged and connected images in ascending order according to the amount of images comprising the respective group; and
placing the groups onto the grid, beginning with the group having the smallest amount of images therein and proceeding to the group having the largest amount of images therein, so as to form the virtual slide.

13. A method according to claim 12 wherein placing each of the non-correlatable and unmergeable images onto the grid further comprises placing each of the non-correlatable and unmergeable images, the non-correlatable and unmergeable images comprising empty background information, onto the grid at a position corresponding to the best estimate coordinate pair therefor.

14. A method according to claim 12 wherein placing the groups onto the grid further comprises placing each group onto the grid by centering the respective group at a grid location corresponding to a minimized mean square error between an actual image dimension and the average effective image dimension for each of the merged and connected images within the group.
